(19) United States
(12) Patent Application Publication
(10) Pub. No.: US 2026/0338592 A1
(43) Pub. Date: Oct. 29, 2026

(54) METHOD FOR CALCULATING THE MASS OF A VEHICLE AND SYSTEM FOR CALCULATING THE MASS OF SAID VEHICLE

(71) Applicant: STREPARAVA S.P.A. CON SOCIO UNICO, Adro (BS) (IT)

(72) Inventors: Diego Delvecchio, Adro (BS) (IT); Agnese Palmieri, Adro (BS) (IT); Giulia Simoni, Adro (BS) (IT); Andrea Zorzutti, Adro (BS) (IT)

(21) Appl. No.: 19/106,013

(22) PCT Filed: Aug. 16, 2023
(86) PCT No.: PCT/IB2023/058225

§ 371 Date: Feb. 24, 2025

(30) Foreign Application Priority Data
Aug. 26, 2022 (IT) 102022000017673

(51) Int. Cl. G01G 19/02

(52) U.S. Cl. CPC G01G 19/022; B60G 2400/60

(57) ABSTRACT

Method for determining the mass of a vehicle, in particular a land vehicle, preferably a light commercial vehicle; the method comprises the steps of: a) detecting a force exerted on the suspension assembly in particular by the sprung mass; b) detecting at least one force acting on the state of inertia of the sprung mass; c) detecting at least one parameter of the vehicle in particular provided by a second detecting device assembly of the vehicle; the method comprising the step of defining the mass of the vehicle based on one or more of the following parameters: on the at least one detected force exerted on the suspension assembly; on the at least one detected force acting on the state of inertia of the sprung mass; and on at least one parameter of the engine assembly or the command assembly of the vehicle.

### CROSS-REFERENCE TO RELATED APPLICATIONS

This patent application claims priority from Italian Patent Application No. 102022000017673 filed on Aug. 26, 2022, the entire disclosure of which is incorporated herein by reference.

### TECHNICAL FIELD

The present invention concerns a method for calculating the mass of a land vehicle and a system for calculating the mass of said vehicle.

In particular, the invention concerns a method for calculating the mass of a land vehicle through a system installed on board the vehicle itself.

### BACKGROUND

U.S. Pat. No. 5,610,372 shows a method for dynamically measuring the mass of a vehicle by means of sensors placed on the vehicle. However, the implementation of such a method is complex and sometimes such measurements do not have a desired degree of accuracy.

### SUMMARY

Aim of the present invention is to provide a way to estimate the mass of a vehicle that reduces at least one of the drawbacks of the prior art.

According to the present invention there is therefore provided a method for determining the mass of a vehicle in accordance with claim 1.

According to another aspect of the present invention there is realized an estimation system for estimating the mass of a vehicle in accordance with claim 12.

According to another aspect of the present invention there is realized a retrofit kit for a vehicle in accordance with claim 13.

According to another aspect of the present invention there is realized a vehicle in accordance with claim 14.

According to another aspect of the present invention there is realized a method of increasing the functionalities of a vehicle in accordance with claim 15.

### BRIEF DESCRIPTION OF THE DRAWINGS

Further characteristics and advantages of the present invention will appear clear from the following description of non-limiting embodiment examples, with reference to the figures of the attached drawings, wherein:

FIG. 1 is a block diagram of a vehicle in accordance with an embodiment of the present invention;

FIG. 2 is a block diagram of a system for calculating the mass of a vehicle in accordance with FIG. 1; and

FIG. 3 is a block diagram of a detail of the system for calculating the mass of FIG. 2,

FIG. 4 is a block diagram of a detail of an optional embodiment of the system for calculating the mass of FIG. 2.

### DESCRIPTION OF EMBODIMENTS

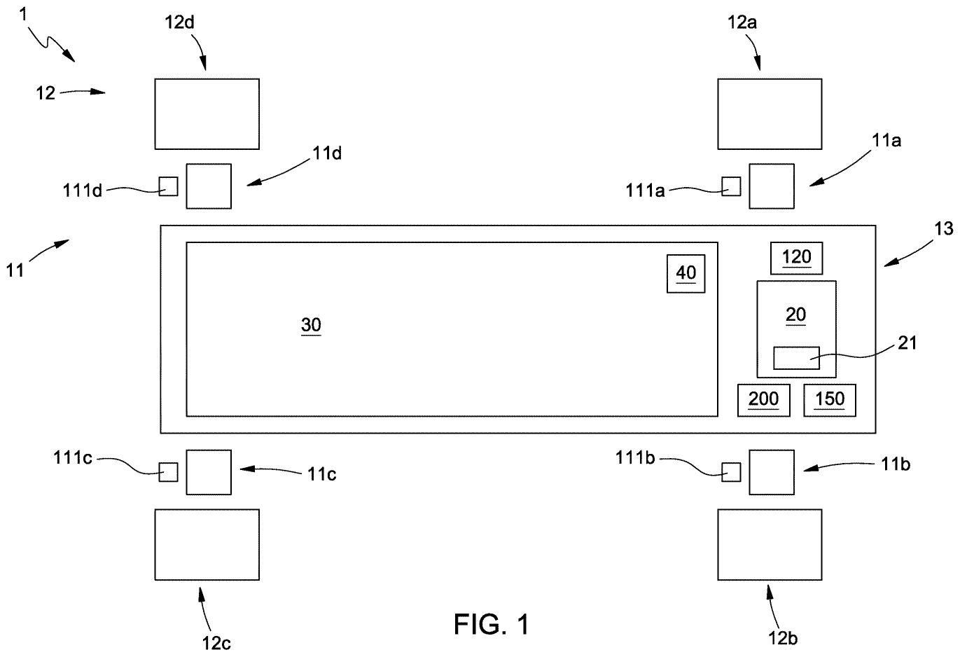

With reference to FIG. 1, reference numeral 1 shows a land vehicle, preferably motorised. In other words, a vehicle moving forward on a ground. In a preferred embodiment, the land vehicle is a light commercial vehicle.

In another embodiment the land vehicle is any type of vehicle, for example a car or a truck of any category, for example but not in a limiting manner a truck of category N in particular belonging to one of the following categories N1, N2 or N3. In addition, the truck may be provided with a trailer or with a semi-trailer.

In other words, this invention applies to any type of land vehicle including trucks of the light-duty type and trucks of the heavy-duty type or adapted to carry heavy loads and with any number of axles.

The vehicle 1 comprises a suspension assembly 11; an unsprung mass assembly 12; and a sprung mass assembly 13 coupled to the unsprung mass assembly 12 via the suspension assembly 11.

In particular, the suspension assembly 11 comprises a plurality of suspensions 11a, 11b, 11c, 11d. In the form shown in FIG. 1 and not limiting the present invention, the suspension assembly 11 comprises four suspensions. It is understood that the invention applies to a vehicle comprising any number of suspensions.

Each suspension 11a, 11b, 11c, 11d preferably comprises a shock absorber.

The unsprung mass assembly 12 is in contact with the ground and preferably comprises a plurality of unsprung masses 12a, 12b, 12c, 12d.

In the form shown in FIG. 1 and not limiting the present invention, the unsprung mass assembly 12 comprises four unsprung masses, in particular each unsprung mass comprises at least one wheel in contact with the ground, in particular the wheel in turn comprises a rim and preferably a tire. It is understood that the invention applies to a vehicle comprising any number of unsprung masses.

In particular, the sprung mass assembly 13 is coupled to the unsprung mass assembly 12 at a plurality of suspension points (also called corners) by means of the plurality of suspensions 11a, 11b, 11c, 11d of the suspension assembly 11.

In the form shown in FIG. 1 and not limiting the present invention, the sprung mass assembly 13 is coupled to the unsprung mass assembly 12 at least at four suspension points by means of the four suspensions 11a, 11b, 11c, 11d of the suspension assembly 11.

The vehicle 1 comprises an engine assembly 20, which is preferably comprised in the sprung mass 13.

The engine assembly 20 in a non-limiting embodiment of the present invention comprises an internal combustion engine. In a non-limiting embodiment of the present invention, the engine assembly 20 comprises a hybrid engine, in particular series or parallel, comprising an internal combustion engine and an electric engine.

In another non-limiting embodiment of the present invention, the engine assembly comprises an electric engine and preferably electric accumulators. In another non-limiting embodiment of the present invention, the engine assembly comprises a fuel cell assembly.

Furthermore, the engine assembly 20 comprises a transmission assembly.

In a non-limiting embodiment, the transmission assembly may comprise a gearbox or a speed variator.

Preferably, the sprung mass assembly 13 comprises a cab 30, in particular comprising a driving compartment and a loading compartment.

Preferably, the driving compartment and the loading compartment may be defined by a single room or by two or more separate rooms.

The vehicle 1 comprises a vehicle command assembly 40 through which the vehicle is driven manually by a driver or autonomously by a self-driving system.

In one embodiment, the command assembly 40 receives commands from the driver through which he drives the vehicle 1. In this embodiment, the command assembly 40 preferably comprises a steering and pedals and is preferably located in the cab 30, in particular in the driving compartment. The engine assembly 20 comprises a control unit assembly 21 comprising one or more control units, for example an engine control unit 21.

The vehicle 1 comprises a detecting device assembly 120 configured to detect at least one parameter of the vehicle 1.

In one embodiment, the detecting device assembly 120 comprises a plurality of detecting devices configured to detect a plurality of parameters of the vehicle 1.

In particular, said parameters of the vehicle 1 can be one or more parameters selected in the parameter group of the vehicle 1 comprising: torque delivered by the engine assembly 20; number of revolutions of the engine assembly 20; setpoint torque delivered/number of revolutions of the engine assembly 20; gearbox parameter of the engine assembly 20, preferably which gear is engaged; accelerator pedal position of the vehicle; brake pedal position of the vehicle; steering position of the vehicle; forward speed of the vehicle; wheel rotation speed, in particular rotation speed of each wheel or pair of wheels on the same axle.

In particular, at least some detecting devices of the detecting device assembly 120 are coupled to the control unit assembly 21.

In particular, at least some detecting devices of the detecting device assembly 120 are coupled to the command assembly 40.

The control unit 21 controls the engine assembly 20 based on the parameters detected by the detecting device assembly 120 coupled to the engine assembly 20 and based on the commands sent by a driver via the control assembly 40.

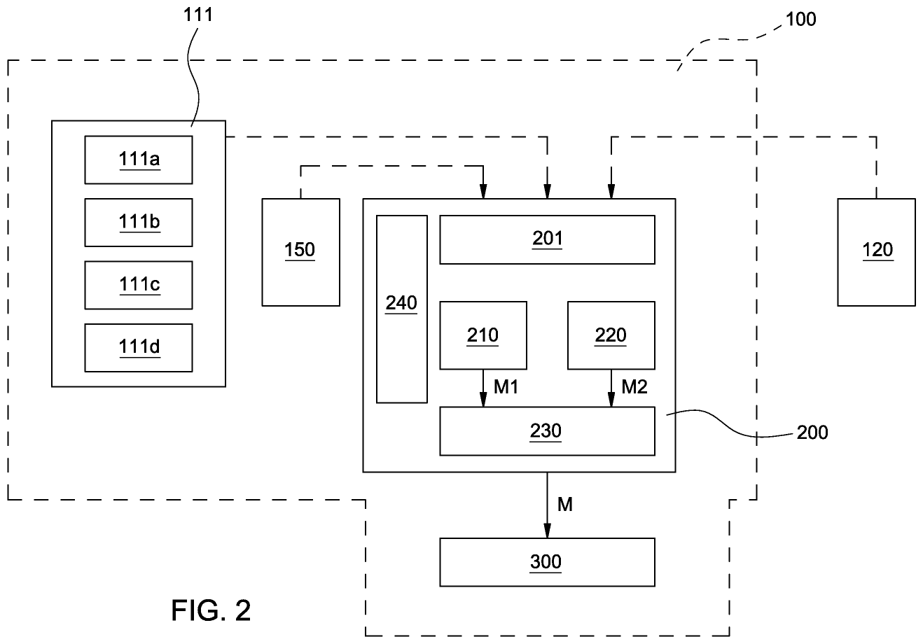

With reference to FIGS. 1 and 2, number 100 shows an estimation system for estimating the mass M of a vehicle, in particular of a commercial vehicle as described above.

In particular, the mass M is the sum of the mass of the unladen vehicle 1, which comprises the unladen sprung mass and the unsprung mass and of any mass loaded on the vehicle, in particular of the loads in the loading compartment and in the driving compartment of the cab 30 (which are part of the sprung mass 13).

The estimation system 100 comprises a detecting device assembly 111 coupled to the suspension assembly 11 of the vehicle 1 to measure at least one parameter related to the force exerted on the suspension assembly 11 of the vehicle 1.

In particular, in the following by the term force exerted on the suspension assembly 11 (or on the suspensions 11a, 11b, 11c, 11d) is preferably meant a spring force and/or a damping force exerted on the suspension assembly 11, for example a compression force and/or an extension force.

In particular, the detecting device assembly 111 detects a plurality of parameters for a plurality of forces exerted on the suspension assembly 11 in the plurality of suspension points.

In a non-limiting embodiment of the present invention, the detecting device assembly 111 comprises at least one detecting device 111a, 111b, 111c, 111d for each suspension 11a, 11b, 11c, 11d.

It is understood that the scope of the present invention extends to the case where the detecting device assembly 111 has any number of detecting devices, e.g. the number of detecting devices is selected based on the number of axles of the vehicle and/or trailer.

In particular, each detecting device 111a, 111b, 111c, 111d detects a parameter related to the force exerted on the respective suspension 11a, 11b, 11c, 11d, in particular the parameter related to the force exerted on the respective suspension 11a, 11b, 11c, 11d, may be a measurement, by means of a load cell, of the force exerted on the respective suspension 11a, 11b, 11c, 11d; and/or a measurement of a linear and/or angular distance of a suspension portion with respect to another suspension portion by means of a linear and/or angular position sensor; and/or a measurement of the linear and/or angular relative position of a point of the sprung mass 13 with respect to a point of the unsprung mass 12 by means of a linear and/or angular position sensor.

In one embodiment, each detecting device 111a, 111b, 111c, 111d comprises a load cell that measures the force exerted on the relative suspension 11a, 11b, 11c, 11d; and/or a position sensor that measures the linear and/or angular distance between a point of the sprung mass or suspension assembly and another point of the sprung mass or suspension assembly, or between a point of the sprung mass 13 and a point of the unsprung mass 12; and/or a pressure sensor that directly measures the force exerted on the respective suspension 11a, 11b, 11c, 11d.

In one embodiment of the present invention, the pressure sensor is omitted.

In one embodiment, the detecting assembly 111, preferably each detecting device 111a, 111b, 111c, 111d, detects, preferably cyclically, said parameter related to the force exerted on the respective suspension 11a, 11b, 11c, 11d.

The estimation system 100 comprises an inertial sensor assembly 150 preferably housed on the sprung mass assembly 13 of the vehicle 1, in particular being rigidly and/or integrally coupled to the sprung mass assembly 13.

In particular, the inertial sensor assembly 150 comprises one or more inertial sensors, in particular one or more accelerometers and/or one or more gyroscopes.

In one embodiment, the inertial sensor assembly 150 comprises an inertial measurement unit which in turn comprises one or more inertial sensors and/or one or more accelerometers and/or one or more gyroscopes.

In a preferred embodiment, the inertial sensor assembly 150 comprises one or more accelerometers that measure the forces along three mutually perpendicular axes; and one or more gyroscopes that measure a rotation speed about three mutually perpendicular axes. In a preferred but non-limiting embodiment, the three perpendicular axes of the accelerometers are the same as the gyroscopes.

In one embodiment, the inertial sensor assembly 150 may comprise a magnetic field sensor also in addition to the sensors described above.

Furthermore, the inertial sensor assembly 150 may comprise a position localization sensor such as a GPS sensor.

The inertial sensor assembly 150 is preferably rigidly and/or integrally fixed and/or comprised in the sprung mass 13 of the vehicle 1 and is configured to detect at least an acceleration and/or a rotation speed and/or a rotation and/or an inclination acting on the sprung mass 13.

In one non-limiting embodiment of the present invention, the inertial sensor assembly 150 is omitted.

In particular, the inertial sensor assembly 150 detects a plurality of forces acting on the sprung mass 13, in particular it monitors the dynamics of the sprung mass 13.

The estimation system 100 comprises a processing assembly 200 configured to calculate the mass M of the vehicle 1 based: on the at least one parameter related to the force exerted on the suspension assembly 11 detected, in particular detected by means of the detecting device assembly 111; and/or on the at least one detected force acting on the sprung mass 13, in particular detected by means of the inertial sensor assembly 150; and/or on at least one parameter of the vehicle 1, in particular detected by means of the detecting device assembly 120.

Furthermore, the processing assembly 200 comprises a memory in which at least one nominal data item of the vehicle or of a list of vehicles to be selected during installation is loaded. The at least one nominal data item of the vehicle is selected from a list of nominal data of the vehicle comprising: ground mass on each wheel (unladen vehicle); front unsprung mass; rear unsprung mass; roll moment of inertia (unladen vehicle); pitch moment of inertia (unladen vehicle); yaw moment of inertia (unladen vehicle); centre of gravity height (unladen vehicle); pitch; front track; rear track; steering ratio; roll gradient; pitch gradient; reduced engine inertia at the shaft; gearbox ratios; gearbox ratio efficiency; front differential ratio (if present); front differential efficiency (if present); rear differential ratio (if present); rear differential efficiency (if present); centre differential ratio (if present); centre differential efficiency (if present); front axle drive torque distribution; front section; drag coefficient; front aerodynamic lift coefficient; rear aerodynamic lift coefficient; total aerodynamic lift coefficient; total pitch aerodynamic coefficient; ground stiffness curve in parallel stroke of the front suspension; ground stiffness curve in parallel stroke of the rear suspension; ground stiffness curve in anti-parallel stroke of the front suspension; ground stiffness curve in anti-parallel stroke of the rear suspension; ground damping curve of the front suspension; ground damping curve of the rear suspension.

With reference to FIG. 2, the processing assembly 200 is connected in communication with the detecting device assembly 111 to receive the at least one parameter related to the force exerted on the suspension assembly 11 detected.

In particular, the processing assembly 200 is connected in communication with the inertial sensor assembly 150 to receive the at least one detected force acting on the sprung mass.

In particular, the processing assembly 200 is connected in communication with the detecting device assembly 120 to receive the at least one parameter of the vehicle 1.

In a preferred but non-limiting embodiment of the present invention, the processing assembly 200 is connected to the detecting device assembly 120, preferably via a communication bus assembly of the vehicle 1. In particular, via one or more ports of the communication bus assembly of the vehicle 1 or by installing a new communication connector/port along the communication bus assembly of the vehicle.

The system 100 comprises a communication port or a connector configured to be connected to the communication bus assembly of the vehicle to connect the processing assembly 200 to the detecting device assembly 120 of the vehicle 1.

In particular, the communication port or the connector of the system 100 is connected to a communication port or to a connector of the communication bus assembly.

In one embodiment, a new communication port or a new connector is installed along the communication bus assembly of the vehicle 1.

By way of non-limiting example, the communication bus assembly of the vehicle 1 may be one or more of the following CAN-bus and/or Flex-Ray and/or Automotive Ethernet communication buses.

Furthermore, the vehicle 1 comprises a display 300 communicatively coupled to the processing assembly 200 via a cable or wirelessly; and configured to receive from the processing assembly 200 the estimation of the mass M of the vehicle 1, and show it on the display.

In an alternative embodiment, the display 300 is communicatively coupled to the processing assembly 200 via the communication bus assembly of the vehicle 1.

In a preferred embodiment, said display 300 is housed in the cab 30 of the vehicle 1.

With reference to FIG. 2, the processing assembly 200 comprises a conditioning module 201, a calculation module 210, a calculation module 220 and a validation module 230.

All modules and in particular the calculation modules 210, 220 can be different hardware modules, or different software modules that use the same hardware or different hardware, or a hybrid solution of the aforementioned ones.

Furthermore, the processing assembly 200 comprises an activation module 240.

In greater detail, the processing assembly 200 is configured to calculate the mass M of the vehicle 1 through the calculation module 210 using a first algorithm; and/or the calculation module 220 using a second algorithm.

Preferably, the first algorithm and the second algorithm provide for different calculation processes.

In one embodiment of the present invention, the two calculation modules 210 and 220 are configured to calculate a respective estimation M1 and M2 of the mass M of the vehicle 1 at least partly independently of each other and are preferably based on at least partly different inputs.

In a preferred embodiment, the two calculation modules 210 and 220 implement two different calculation methods.

In particular, the calculation module 210 is configured to estimate a value M1 of the mass M of the vehicle 1 based on the data detected on the suspension assembly 11 of the vehicle 1, in particular based on the force exerted on the suspension assembly 11 and detected by means of the detecting devices assembly 111.

In particular, the calculation module 210 is configured to estimate the static load on each suspension point based on the forces exerted on the suspension assembly 11 detected by means of the detecting device assembly 111.

The calculation module 220 is configured to estimate a value M2 of the mass M of the vehicle 1 based on the data related to the longitudinal dynamics and thus of the longitudinal movements of the vehicle 1.

In particular, the calculation module 220 is configured to estimate a value M2 of the mass M of the vehicle 1 based on the forces acting on the vehicle 1 detected by the inertial sensor assembly 150 and/or based on the parameters of the vehicle 1 detected by means of the detecting device assembly 120, in particular when the vehicle 1 is in motion.

With reference to FIG. 2, the processing assembly 200 receives the data in input from the detecting device assembly 111 and/or from the inertial sensor assembly 150 and/or from the detecting device assembly 120 and checks whether one or more data are absent, in particular for a malfunction of one of the assemblies 111, 150, 120.

In one embodiment, the conditioning assembly 201 filters and/or synchronizes the data received in input from the detecting device assembly 111 and/or from the inertial sensor assembly 150 and/or from the detecting device assembly 120 in accordance with a conditioning process for the first calculation module 210 and/or for the second calculation module 220.

In particular, the conditioning assembly 201 receives the data from the detecting device assembly 111 and calculates a stroke speed for each suspension 11a, 11b, 11c and 11d based on the data of the respective detecting device 111a, 111b, 111c and 111d associated, and provides it to the calculation module 210.

In particular, the calculation module 210 receives from the conditioning assembly 201 the data detected by the detecting device assembly 111, in particular by stroke sensor(s) and/or pressure sensor(s); and/or by the detecting device assembly 120, in particular the parameters of the vehicle 1; and/or the values detected by means of the inertial sensor assembly 150.

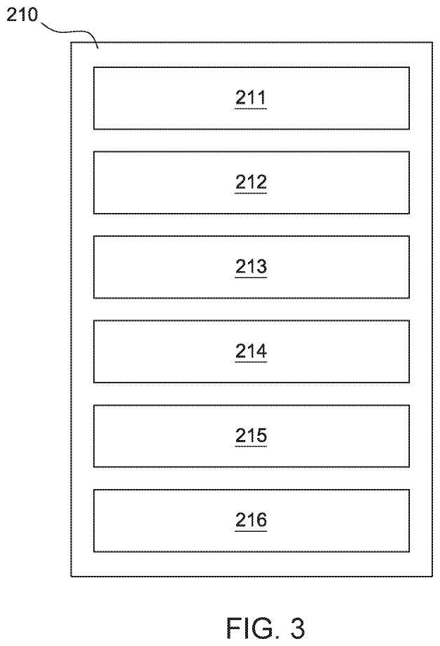

In particular, with reference to FIG. 3, the calculation module 210 comprises a calculation unit 211 that receives the data from the detecting device assembly 111 coupled to the suspension assembly 11 and from these it estimates the forces, in particular the vertical spring forces, acting on the suspension assembly 11, in particular through the use of a first look-up table and/or a first polynomial function.

In particular, the calculation module 210 comprises a calculation unit 212 that receives the data from the detecting device assembly 111 coupled to the suspension assembly 11 and from these it estimates the vertical forces exerted by the end buffers of the suspension assembly 11, in particular through the use of a second look-up table and/or a second polynomial function.

In one embodiment, the calculation unit 211 and the calculation unit 212 are defined by a single calculation unit and the respective look-up tables and/or the respective polynomial functions are defined by a single look-up table and/or a single polynomial function.

In particular, the calculation module 210 comprises a calculation unit 213 that receives the data from the detecting devices 111 coupled to the suspension assembly 11 and from these it estimates the anti-parallel stroke forces of the suspension assembly 11, for example the vertical forces exerted by the anti-roll bars, in particular through the use of a third look-up table and/or a third polynomial function. In particular, the calculation unit 213 receives the data from the detecting devices 111a and 111b of the right and left 11a and 11b front suspension unit or from the detecting devices 111c and 111d of the right and left 11c and 11d rear suspension unit and based on the difference between the travel of the right suspension 11a or 11c and the relative left suspension 11b or 11d obtains the anti-parallel stroke forces of the suspension assembly 11.

In particular, the calculation module 210 comprises a calculation unit 214 that receives the data from the detecting devices 111 coupled to the suspension assembly 11 and from these it estimates the damping forces of the suspension assembly 11, in particular of the shock absorbers of the suspension assembly 11, in particular through the use of a fourth look-up table and/or a fourth polynomial function. In particular, the calculation unit 214 receives the stroke speed of the suspension assembly 11, in particular of each suspension 11a-11d of the suspension assembly 11, from the conditioning block 201 and based on said stroke speed it calculates the damping force of the suspension assembly 11.

In particular, the calculation module 210 comprises a calculation unit 215 that receives the data of the torque values and of the gear of the gearbox from the detecting device assembly 120 and from these it estimates the compensation forces due to the engine assembly 20 through a fifth function.

In particular, the calculation module 210 comprises a calculation unit 216 that receives the data of the forward speed of the vehicle 1 from the detecting device assembly 120 and estimates the aerodynamic forces in particular a vertical component of the aerodynamic force and/or a pitch component of the aerodynamic force acting on the vehicle 1 through a sixth function

In one embodiment, any one or more of the calculation units 211, 212, 213, 214, 215, 216 may be omitted and the calculation module 210 operates with the other calculation units. In other words, protection is also intended to extend to the case in which any one or more of the calculation units 211, 212, 213, 214, 215, 216 is absent. The minimum number of calculation units 211, 212, 213, 214, 215, 216 is one.

The calculation module 210 is configured to estimate the mass M1 of the vehicle 1 based on the data in output of one or more of the calculation units 211, 212, 213, 214, 215, 216, in particular based on the forces acting on the vehicle 1 calculated through one or more of the calculation units 211, 212, 213, 214, 215, 216.

In particular, the calculation module 210 based on the calculations provided by one or more of the calculation units 211, 212, 213, 214, 215, 216 calculates an estimation of the sprung mass 13 and subsequently applies to the estimation of the sprung mass 13 the value of the unsprung mass 12 (which is fixed) and provides the value M1 of the mass M of the vehicle 1 (which, as said above, is the total mass of the vehicle 1 thus comprising both the sprung mass 13 and the unsprung mass 12).

Furthermore, the calculation module 210 is configured to estimate the distribution of the value M1 of the mass M on each suspension 11a, 11b, 11c, 11d of the suspension assembly 11 based on the data calculated by one or more of the calculation units 211, 212, 213, 214, 215, 216. In other words, the calculation module 210 is configured to define the value of the sprung mass 13 acting on each suspension 11a, 11b, 11c, 11d of the suspension assembly 11 based on the data calculated by one or more of the calculation units 211, 212, 213, 214, 215, 216.

In a preferred but non-limiting embodiment, one or more of the calculation units 211, 212, 213 and 214 comprise a respective look-up table and/or a respective polynomial function for each suspension 11a, 11b, 11c, 11d of the suspension assembly 11.

In other words, one or more of the calculation units 211, 212, 213 and 214 comprise a respective look-up table and/or a respective polynomial function for each respective detecting device 111a, 111b, 111c and 111d of the respective suspension unit for each suspension 11a, 11b, 11c, 11d of the suspension assembly 11.

Indeed, one or more of the look-up tables and/or the respective polynomial functions define a mathematical model of the stiffness curve of each suspension 11a, 11b, 11c, 11d of the suspension assembly 11.

Furthermore, in a preferred but non-limiting embodiment, the calculation module 210 is configured to estimate the position of the centre of gravity in a horizontal plane of the vehicle 1 (and of the ground) based on the estimation of the distribution of the value M1 of the mass M on each suspension 11a, 11b, 11c, 11d and preferably based on the nominal data of the vehicle 1 present in the memories of the processing assembly 200 and related to the pitch and/or front track and/or rear track of the vehicle 1.

In one embodiment, the conditioning module 201 calculates the pitch acceleration based on the data received from the inertial sensor assembly 150 and provides it to the calculation module 210.

In another embodiment, the conditioning module 201 calculates the pitch acceleration based on the data received from the detecting device assembly 111 and/or from the detecting device assembly 120 and provides it to the calculation module 210.

Furthermore, the calculation module 210 is configured to estimate the position of the height of the centre of gravity of the vehicle 1 by means of the pitch motion equilibrium equation based: on the forces on the suspensions 11 detected by means of the sensor assembly 111; on the inertial contribution linked to the longitudinal acceleration; and preferably on the pitch acceleration calculated by the conditioning block 201, preferably by means of the data of one or more of the calculation units 211, 212, 213, 214, 215, 216 and/or on a value of the acceleration of the vehicle 1 calculated from the value of the speed detected by means of the inertial sensor assembly 150 and/or the detecting device assembly 120.

In a preferred version, the calculation module 210 provides in output one or more of the following measurements selected from the group of measurements: the individual mass values calculated and acting on each suspension 11a, 11b, 11c, 11d; the masses calculated and acting on the two front suspensions 11a, 11b; the masses calculated and acting on the two rear suspensions 11c, 11d; the total mass M1 calculated; the position of the centre of gravity in space; and moments of inertia with respect to a triad of axes orthogonal to each other.

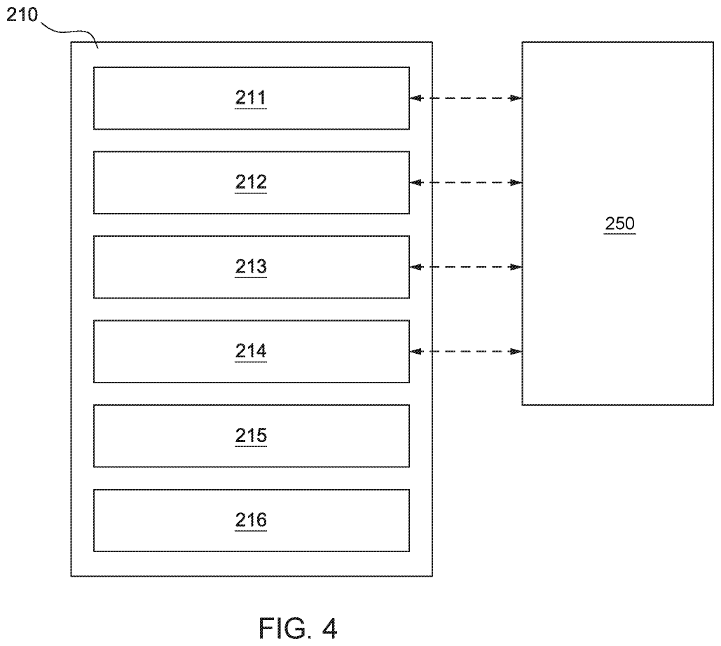

In a preferred but non-limiting embodiment of the present invention shown in FIG. 4, the processing assembly 200 comprises a control module 250 which defines and/or regulates and/or calibrates at least partially parameters or other portion of one or more of the first, second, third and fourth look-up table and/or at least partially parameters or other portion of one or more of the first, second, third and fourth polynomial function of one or more of the respective calculation units 211, 212, 213 and 214, preferably for each suspension 11a, 11b, 11c, 11d of the suspension assembly 11.

In more detail, the control module 250 receives in input the data from the detecting device assembly 120, in particular the parameters of the vehicle 1, preferably one or more of the following values: engine revolutions, gear used, accelerator position, torque provided by the engine, brake position; and/or the values detected by means of the inertial sensor assembly 150 and defines a stiffness curve of the suspension assembly 11, in particular of each suspension 11a, 11b, 11c, 11d of the suspension assembly 11 in particular through a machine learning algorithm.

In an optional embodiment, the control module 250 receives in input also the signals of the detecting assembly 111, in particular of each respective detecting device 111a, 111b, 111c and 111d.

Furthermore, the control module 250 from the stiffness curve of the suspension assembly 11, in particular of each suspension 11a, 11b, 11c, 11d of the suspension assembly 11 defines at least partially parameters or other portion of one or more of the first, second, third and fourth look-up table and/or at least partially parameters or other portion of one or more of the first, second, third and fourth polynomial function of one or more of the respective calculation units 211, 212, 213 and 214, preferably for each suspension 11a, 11b, 11c, 11d of the suspension assembly 11 and compares them with the respective parameters and/or the portions currently in use in one or more of the respective calculation units 211, 212, 213 and 214. If the differences of said comparison fall within a predefined comparison range, the control module 250 modifies said at least partially parameters or other portion of one or more of the first, second, third and fourth look-up table and/or at least partially parameters or other portion of one or more of the first, second, third and fourth polynomial function of one or more of the respective calculation units 211, 212, 213 and 214, if, on the other hand, the differences are outside the predefined comparison range, the control module 250 emits an error signal to define a possible malfunction, a tampering or a decay of the characteristics of the suspension system, in particular for each suspension 11a, 11b, 11c, 11d of the suspension assembly 11. In this case the error signal can be shown on the display together with the calculated value M of the mass or it can be shown on the display and interrupt the display of the calculated value M of the mass.

In particular, the error signal can be shown on the display together with the individual mass value calculated and acting on each suspension 11a, 11b, 11c, 11d or interrupt displaying only the individual mass value of the calculated value calculated and acting on the suspension 11a, 11b, 11c, 11d related to the error message.

In other words, the main objective of the control module 250 is to obtain a stiffness curve of the suspension assembly 11, in particular of each suspension 11a, 11b, 11c, 11d (represented by a point cloud) that can be compared with the stiffness curve implemented (through at least some of the look-up tables and/or polynomial functions) by the calculation module 210 to identify conditions of decay (drift) or sudden change (jump) of the characteristic curve of the suspension assembly 11 in particular of each suspension 11a, 11b, 11c, 11d and optionally emit an error signal. The stiffness curve that is obtained is compared with the characterization obtained by combining a part or all the contributions 211, 212, 213, 214. By analysing the vehicle data while it is running, it is wished to define a model that provides as a result the stiffness curve of the suspension assembly 11, in particular of each suspension 11a, 11b, 11c, 11d. The “model-based” approach for this solution is influenced by many variables of difficult calibration that makes this approach unreliable, for this reason a machine learning algorithm is used.

The definition of the stiffness curve(s) requires the analysis of a large amount of data under different driving conditions of the vehicle. The time to obtain the parameters to be compared with the data of the calculation method 210, in particular with the data of the calculation units 211, 212, 213 and 214 may also be a few hours.

Thanks to the present invention, it is possible to generate an error signal linked to a possible malfunction, a tampering or a decay of the characteristics of the suspension assembly 11, in particular for each suspension 11a, 11b, 11c and 11d.

In the embodiment comprising the control module 250, the calculation module 220 may be omitted.

The calculation module 220 calculates a value M2 of the mass M based on the torque delivered by the engine assembly 20 and on the forward speed, in particular longitudinal.

Preferably the torque delivered by the engine assembly 20 is detected by the detecting device assembly 120.

Preferably, the forward speed, in particular longitudinal, is detected by means of the detecting device assembly 120 and/or by means of the inertial sensor assembly 150.

The second calculation block 220 uses the data in input and the mathematical model of the longitudinal dynamics to identify the value M2 of the mass M through a series of repeated calculations to reduce the estimation error.

In particular, the second calculation block 220 is configured to calculate the value M2 of the mass M of the vehicle 1 by the following relationship:

$$M 2 ∝ \frac{{F}_{traction} - {F}_{air} - {F}_{friction} - {F}_{slope}}{\dot{v}}$$

wherein \dot{v} is defined by the longitudinal acceleration detected by the inertial sensor assembly 150 or is defined by the derivative over time of the forward speed of the vehicle 1 detected by the detecting device assembly 120.

In a non-limiting and exemplary embodiment, the F_{trazione} is calculated based on the following relationship:

$${F}_{traction} ∝ \frac{{T}_{e} {η}_{tf} {i}_{tf}}{{r}_{w}} - ( {I}_{e} + {I}_{t} + \frac{{I}_{d}}{{i}_{t}^{2}} + \frac{{I}_{w}}{{i}_{tf}^{2}} ) \frac{{i}_{tf}^{2} \dot{v}}{{r}_{w}^{2}}$$

wherein: Tₑ is the torque delivered by the engine; η_{tf} is a generalized performance parameter; i_{tf} is the final reduction ratio; r_{w} is the wheel radius; the element to the right of the equation takes into account all rotational inertial terms referred to engine, transmission and wheels.

In a non-limiting and exemplary embodiment,
Fₐᵣᵢₐ is the resistive component due to aerodynamic friction, in a non-limiting and exemplary embodiment, it is calculated based on the following relationship:

$${F}_{air} ∝ \frac{1}{2} {ρ}_{air} {c}_{d} {{A}_{f} ( deltav )}^{2}$$

wherein preferably: ρₐᵢᵣ is the air density parameter; c_{d} is the aerodynamic friction coefficient, in particular that depends on the shape of the vehicle and that varies in each vehicle model; A_{f} is the frontal area of the vehicle; deltav is the relative forward speed with respect to the air speed, in particular in one embodiment it is assumed for simplicity's sake that the air speed is zero and consequently deltav is equal to the forward speed, preferably longitudinal, of the vehicle 1.

In particular, F_{friction} is the resistive component due to rolling friction, in a non-limiting and exemplary embodiment, it is calculated based on the following relationship:

F_{friction}∝fᵣmg cos(θ)

wherein preferably: fᵣ is a rolling friction parameter; m is the mass of the vehicle; g is the acceleration of gravity; θ is the inclination of the road.

In particular, the calculation block 220 cyclically calculates the parameter fᵣ based on the detected slope of the road, the forward speed of the vehicle and the torque delivered by the engine assembly.

In particular, F_{gravity} is the component due to the force of gravity acting on the vehicle, in a non-limiting and exemplary embodiment, it is calculated based on the following relationship:

F_{gravity}∝mg(sin(θ))

wherein preferably: m is the mass of the vehicle; g is the acceleration of gravity; and θ is the inclination of the road.

In particular, when the calculation module 220 is activated for the estimation of the second value of M2, during the first calculation cycle, the value m used in the relationship to calculate F_{friction} and/or in the relationship to calculate the F_{gravity} is the value of the unladen mass of the vehicle 1 defined by the nominal data and stored in the memory of the calculation assembly 200 or the value M2 calculated by the calculation module 220 in a previous step or the value M calculated by the processing assembly 200 of the mass calculated in the previous cycle or in a previous step. From the subsequent cycle onwards, the value m used in the relationship to calculate F_{friction} and/or in the relationship to calculate the F_{gravity} is equal to the value M2 calculated in the previous cycle by the calculation module 220 or to the value M calculated in the previous cycle by the processing unit 200.

In an alternative non-limiting embodiment of the present invention, the value m used in the friction formula and/or in the gravity formula initially and/or in the subsequent cycles is the value M1 calculated by the calculation module 210.

In a non-limiting embodiment of the present invention, one or more of the parameters shown above, in particular one or more of the following parameters: η_{tf}; i_{tf}; r_{w}; ρₐᵢᵣ; c_{d}; A_{f} are continuously updated by the calculation block 220 based on the detected speed, on the torque delivered by the engine assembly in almost stationary conditions (i.e. constant and level forward speed) based on an optimization algorithm. The parameters thus identified are updated in real time in the formula of the mass M2. This value, calculated in parallel with the estimation of the mass M1 returned by the calculation block 210, allows firstly to check its reliability.

Some of the parameters indicated above, which are known parameters of the vehicle 1, for example reduction ratios, aerodynamic components and rolling friction are provided to the control block 220 by means of values marked either by the nominal data of the vehicle or identified experimentally during the installation of the system on board the vehicle.

In one embodiment one or more of the components Fₐᵢᵣ; F_{friction}; Fₛₗₒₚₑ is omitted in the formula for calculating the M2.

In a non-limiting embodiment, the processing assembly 200 is configured such that if the estimated mass value M1 provided by the calculation module 210 and the mass value M2 provided by the calculation module 220 are different by a value greater than a determined confidence threshold, the processing assembly 200 performs a reset of the calculation module 210 and/or of the calculation module 220.

In one embodiment of the present invention, the activation module 240 receives in input the data of the detecting device assembly 111 and/or the inertial sensor assembly 150 and/or the detecting device assembly 120, preferably directly or from the conditioning module 201, and enables the calculation of the value M1 calculated by the calculation module 210 when the vehicle is stationary and preferably substantially level and/or moving in uniform rectilinear motion or approximate thereto.

In particular, in a preferred non-limiting embodiment of the present invention, enabling the calculation of the value M1 calculated by the calculation module 210 when the vehicle is stationary and preferably substantially level and/or moving in uniform rectilinear motion or approximate thereto, means that the activation module 240 activates the calculation module 210 and/or enables the use of the values M1 calculated by the calculation module 210 within the processing assembly 200 and/or enables the sending to the display 300 of the values M1 calculated by the calculation module 210 only when the vehicle is stationary and preferably substantially level and/or moving in substantially uniform rectilinear motion or approximate thereto.

In particular, the activation module 240 enables the use of the value M1 calculated by the calculation module 210 when at least one of the following conditions 1.x) below is met:
1.1) Forward speed less than a forward speed threshold, preferably less than 160 km/h, in particular less than 140 km/h;
1.2) Longitudinal acceleration less than a longitudinal acceleration threshold, preferably less than 1 m/s2, in particular less than 0.3 m/s2;
1.3) Transverse acceleration less than a transverse acceleration threshold preferably less than 1 m/s2, in particular less than 0.2 m/s2;
1.4) Brake pedal not depressed
1.5) Steering angle detected less than a steering angle threshold, preferably less than 15°, in particular less than 5°, preferably this condition is used only if detected forward speed, preferably longitudinal, is less than 30 km/h, preferably less than 15 km/h, otherwise this condition is not used;
1.6) Longitudinal road slope less than a longitudinal slope threshold, preferably less than 3°, in particular less than 2°, in particular less than 1°;
1.7) Road bank slope less than a bank slope threshold, less than 3°, in particular less than 2°, in particular less than 1°.

In particular, in a preferred embodiment the activation module 240 activates the calculation module 210 and/or enables the use of the values M1 calculated by the calculation module 210 within the processing assembly 200 and/or enables the sending to the display 300 of the values M1 calculated by the calculation module 210 only when it detects at least one of the conditions from 1.1 to 1.7.

In a preferred but non-limiting embodiment of the present invention, the activation module 240 activates the calculation module 210 and/or enables the use of the values M1 calculated by the calculation module 210 within the processing assembly 200 and/or enables the sending to the display 300 of the values M1 calculated by the calculation module 210 only when all conditions 1.1 to 1.7 are met, always taking into account that the condition 1.5 must be met only in the case in which also the relative reported sub-condition is detected, otherwise it can be ignored.

Thanks to this function, the calculation module 210 is activated and/or enabled only when it is in an optimal condition to provide a correct estimation M1 of the mass M of the vehicle 1. This increases the reliability of the system 100 and of its estimations M.

In one embodiment of the present invention, the activation module 240 receives in input the data of the detecting device assembly 111 and/or the inertial sensor assembly 150 and/or the detecting device assembly 120, preferably directly or from the conditioning module 201, and enables the calculation of the value M2 calculated by the calculation module 220 only when the vehicle 1 is accelerating along a rectilinear path or approximate thereto.

In particular, in a preferred non-limiting embodiment of the present invention enabling the calculation of the value M2 calculated by the calculation module 220 only when the vehicle 1 is accelerating along a rectilinear path or approximate thereto means that the activation module 240 activates the calculation module 220 and/or enables the use of the values M2 calculated by the calculation module 220 within the processing assembly 200 and/or enables the sending to the display 300 of the values M2 calculated by the calculation module 220 only when the vehicle 1 is accelerating along a rectilinear path or approximate thereto.

In particular, the activation module 240 enables the use of the value M2 calculated by the calculation module 220 when at least one of the following conditions 2.x) below is met:
2.1) Brake pedal not depressed;
2.2) Clutch pedal not depressed (in case of vehicle with manual gearbox) or shift signal in progress not active (in case of vehicle with automatic gearbox);
2.3) Forward speed preferably longitudinal greater than a forward speed threshold, preferably greater than 5 km/h, in particular greater than 10 km/h;
2.4) Forward acceleration preferably longitudinal greater than a forward acceleration threshold, preferably greater than 0.1 m/s2, preferably greater than 0.3 m/s2;
2.5) Jerk less than a jerk threshold, preferably less than 3 m/s3, in particular less than 1 m/s3;
2.6) Yaw speed less than a yaw speed threshold, preferably less than 20°/s, preferably less than 10°/s;
2.7) Drive torque reduced at the wheels less than a first drive torque threshold, preferably less than 7500 Nm, in particular less than 5000 Nm;
2.8) Drive torque delivered by the engine assembly 20 greater than a second drive torque threshold, preferably greater than 50 Nm, preferably greater than 100 Nm;
2.9) Longitudinal road slope less than a longitudinal road slope threshold, in particular less than 20°, preferably less than 10°
2.10) Road bank slope less than a road bank slope threshold, preferably less than 6°, in particular less than 3°.

In particular, in a preferred embodiment the activation module 240 activates the calculation module 220 and/or enables the use of the values M2 calculated by the calculation module 220 within the processing assembly 200 and/or enables the sending to the display 300 of the values M2 calculated by the calculation module 210 only when it detects at least one of the conditions from 2.1 to 2.10.

In a preferred but non-limiting embodiment of the present invention, the activation module 240 enables the use of the measurement M2 calculated by the calculation module 220, in particular by activating the calculation module 220 and/or by enabling the use of the values M2 calculated by the calculation module 220 within the processing assembly 200 and/or by enabling the sending to the display 300 of the values M2 calculated by the calculation module 220, only when all conditions 2.1 to 2.10 are met.

Thanks to this function, the calculation module 220 is activated and/or enabled only when it is in an optimal condition to provide a correct estimation M2 of the mass M of the vehicle 1. This increases the reliability of the system 100 and of its estimations.

In a preferred but non-limiting embodiment of the present invention, the condition 2.1 is removed and the calculation block 220 performs the estimation M2 by adding a braking contribution component to the relationship M2 indicated above. In particular, the braking contribution to the estimation of M2 is given by

$$\frac{{\sum }_{1}^{n} {F}_{x , i}}{{a}_{x}}$$

Wherein

$${F}_{x , i} = \frac{{T}_{brk , i}}{{R}_{L , i}} = \frac{{μ}_{i} \cdot {p}_{i} \cdot 2 \cdot {A}_{i} \cdot {R}_{brk , i}}{{R}_{0 , i} - \frac{{F}_{z , i}}{{K}_{z , i}}}$$

### Wherein:

The subscript i indicates the i-th wheel and n indicates the number of total wheels.
Fₓ indicates the longitudinal force
T_{brk} indicates the braking torque
M indicates the brake disc-plate friction coefficient
A indicates the brake pad area
R_{b} indicates the effective radius of the brake pad
R_{L} indicates the radius under load of the wheel tire
R₀ indicates the undeformed radius of the tire
F_{z} indicates the vertical load on the tire
K_{z} indicates the radial stiffness of the tire.

When the calculation module 220 does not perform the estimation of the mass M2 it sends the last valid mass M2 estimation.

In a non-limiting embodiment of the present invention, the calculation module 220 sends the last valid mass estimation only if time not greater than a time threshold has not elapsed since the last valid mass M2 estimation.

Furthermore, in one embodiment the activation module 240 resets the calculation module 210 and/or the calculation module 220 (and consequently the calculation of the values M1 and/or M2) when it detects that the vehicle 1 has undergone a load variation related to the sprung mass 13. In particular, it resets the calculation module 210 and/or the calculation module 220 (and consequently the calculation of the values M1 and/or M2) when it detects at least one of the conditions 3.x):
3.1) opening/closing of doors and/or loading hatches through the data received from door and/or hatches opening detecting sensors of the detecting device assembly 120;
3.2) Difference between the value M1 calculated by the calculation module 210 and the value M1 calculated previously beyond a first difference threshold and/or between the value M2 calculated by the calculation module 220 and the value M2 calculated previously beyond a second difference threshold and/or difference between the value M1 and the value M2 beyond a third difference threshold calculated by the respective calculation modules 210 and 220. In a non-limiting embodiment, the difference thresholds may be absolute values or percentages with respect to the value M1 and/or M2.

Thanks to the activation module 240 the reliability of the measurements M1 and/or M2 has increased because the conditions shown above increase the reliability of the estimations M1 and/or M2 and consequently of the estimation M.

Furthermore, in a non-limiting embodiment of the present invention the validation module 230 detects whether the measurements of each calculation module 210, 220 are valid, in particular by checking that the variance of a plurality of measurements of each calculation module 210, 220 in a time range falls within a determined variance threshold and/or whether the differences between the measurements of the two calculation blocks 210, 220 are greater than a determined difference threshold.

The processing assembly 200 calculates a first quality index of the estimation M1, in particular the calculation module 210 calculates the first quality index.

The first quality index of the estimation M1 is calculated based on the signals received, in particular by checking whether all the signals are received or not and the quality of the value of the signals received.

The processing assembly 200 calculates a second quality index of the estimation M2, in particular the calculation module 220 calculates the second quality index.

The second quality index of the estimation M2 is calculated based on the variance of the estimations M2 and/or based on the signals received, in particular by checking whether all the signals are received or not and the quality of the value of the signals received.

The validation module 230 checks whether both quality indices are below a respective threshold, i.e. whether both the estimations M1 and M2 are considered as reliable (e.g. at full capacity).

In the case in which one of the two estimations M1 or M2 has a quality index below a respective quality index threshold, the validation module 230 uses only the estimation M1 or M2 that has the quality index above the respective threshold and defines the mass value M to be sent to the display based on said estimation M1 or M2, in particular the value M is equal to said estimation M1 or M2 having the quality index above the threshold.

Also, in the case in which one of the two estimations M1 or M2 has not been received, the validation module 230 uses only the received estimation M1 or M2 and defines the mass value M to be sent to the display based on said received estimation M1 or M2, in particular the mass value M is equal to said received estimation M1 or M2.

In the case in which both two estimations M1 or M2 have a quality index above the threshold, the validation module 230 compares the estimations M1 and M2 evaluating whether the difference between the two estimations M1 and M2 is less than a certain difference threshold, if so the validation module 230 validates the estimation M1 and/or M2 and provides in output the value M to the display 300. The value M is given by the value M1 and/or by the value M2. In particular, the value M is given equal to the value M1 or to the value M2 or is an average of the value M1 and of the value M2.

Otherwise if the difference between the estimations M1 and M2 exceeds a certain threshold, the validation module 230 discards the values of the estimations M1 and/or M2.

In one embodiment, the described functions of the validation module 230 may be implemented in whole or in part by the calculation module 210 and/or by the calculation module 220.

In one embodiment, the system 100 shows by means of the display 300 both the value of the measurement M and the quality index of the measurement associated therewith.

In one embodiment, the measurements with a low quality index are discarded as soon as the conditions to have measurements with a higher quality index are in place.

In a non-limiting embodiment, the validation module 230 is omitted and the value M sent to the display is equal to one of the estimation M1 and/or the estimation M2 and/or an average of the estimations M1 and M2.

In one embodiment, one of the two calculation modules 210 and 220 is omitted and the processing assembly 200 operates exclusively with the other of the two calculation modules 210 and 220 not omitted.

In a non-limiting embodiment of the present invention, the system 100 based on the data received from the detecting device assembly 111 and/or from the inertial sensor assembly 150 and/or from the detecting device assembly 120 dialogues with a control unit of the vehicle 1 to send the data indicated above to the control unit of the vehicle 1 so as to optimize or enable one or more of the additional optional functions: calculation of the optimal tire pressure and/or checking of the optimal tire pressure; enabling/disabling of a regenerative braking; traction control; stability control; anti-collision system.

The estimation system 100 can be installed directly on a vehicle 1 during the vehicle assembly step, consequently when the vehicle 1 is partially assembled along an assembly line or can be installed subsequently on a vehicle through a retrofit kit for said vehicle. In this embodiment, the detecting device assembly 120 is already comprised in the vehicle 1 and the estimation system 100 is configured to connect to a communication bus of the vehicle 1 to receive the data from the detecting device assembly 120 of the vehicle 1.

In one embodiment, the detecting device assembly 111 is already installed on the vehicle 1, for example for purposes other than those of estimating the mass of the vehicle 1, in which case the estimation system 100 does not comprise its own detecting device assembly 111 and receives the values of the detecting device assembly 111 of the vehicle via the communication bus of the vehicle 1 to which both the detecting device assembly 111 and the processing assembly 200 are connected.

In one embodiment, the inertial sensor assembly 150 is already installed on the vehicle 1, for example for purposes other than those of estimating the mass of the vehicle 1, in which case the estimation system 100 does not comprise its own inertial sensor assembly 150 and receives the values of the inertial sensor assembly 150 of the vehicle 1 via the communication bus of the vehicle 1 to which both the inertial sensor assembly 150 and the processing assembly 200 of the estimation system 100 are connected.

In particular, the estimation system 100 finds particular application for installation on vehicles 1 that are already mass-produced but without the mass calculation functionality and is installed along the assembly line when the vehicle is at least partially assembled, for example when the vehicle already comprises the suspensions 11, the communication bus of the vehicle 1 to which the estimation system is connected.

In another embodiment, the system 100 is an integral part of the vehicle 1 and is designed together with the vehicle 1 and assembled therewith.

1. Method for determining the mass of a vehicle, particularly a land vehicle, preferably a light commercial vehicle;
the vehicle comprises a suspension assembly, an unsprung mass assembly preferably in use in contact with the ground, a sprung mass assembly coupled to the unsprung mass via the suspension assembly, and preferably an engine assembly;
wherein the sprung mass comprises a compartment on which persons and/or loads may be accommodated; in particular, the unsprung mass assembly comprises a plurality of unsprung masses; in particular, the suspension assembly comprises a plurality of suspensions, wherein each suspension couples an unsprung mass of the plurality of unsprung masses to the sprung mass group at a suspension point; preferably the method uses an estimation system to estimate the mass of the vehicle that comprises a first detecting device assembly and preferably an inertial sensor assembly;
the method comprises at least one of the following three steps of:
detecting at least one parameter related to the force exerted on the suspension assembly in particular by the sprung mass preferably by means of the first detecting device assembly, in particular detecting a plurality of parameters related to a plurality of forces exerted in the plurality of suspension points, in particular a parameter related to the force exerted for each suspension point;
detecting at least one force acting on the sprung mass preferably on the state of inertia of the sprung mass, in particular detecting a plurality of forces acting on the sprung mass, preferably by means of the inertial sensor assembly comprising at least one inertial sensor, in particular an inertial measurement unit monitoring the dynamics of the sprung mass;
detecting at least a parameter of the vehicle in particular provided by a second detecting device assembly of the vehicle, preferably the at least vehicle parameter is selected in the vehicle parameter group comprising: torque delivered by the engine assembly; number of revolutions of the engine assembly; setpoint torque delivered/number of revolutions of the engine assembly; gearbox parameter of the engine assembly, preferably which gear is engaged; accelerator pedal position of the vehicle; brake pedal position of the vehicle; steering position of the vehicle; forward speed of the vehicle; wheel rotation speed, in particular rotation speed of each wheel or pair of wheels on the same axle;
the method comprising the step of calculating a value of the mass of the vehicle based on processing the data collected in the at least one of the three implemented steps; preferably the method comprises the step of showing said calculated mass value on a display to a user of the vehicle.

2. Method of claim 1, wherein the method comprising the step of implementing at least two of said steps a), b), and c), preferably all three of said steps a), b), and c), and of calculating the mass of the vehicle based on the data collected through said implemented steps; in particular, the method comprises the step of defining a value of the mass of the vehicle based on at least two, preferably at least three, of the following data: the at least parameter detected and related to the force exerted on the suspension assembly; the at least one force acting on the sprung mass preferably on the state of inertia of the sprung mass; and the at least one parameter of the vehicle, in particular based on the detected speed of the vehicle and the torque delivered by the engine assembly.

3. Method of claim 1, the method comprising implementing the step a), in particular the method comprising the step of detecting at least one parameter related to a force exerted on the suspension assembly in particular by the sprung mass preferably continuously, in particular detecting a plurality of forces exerted in the plurality of suspension points, in particular a force exerted for each suspension point; and wherein the method comprises the step of calculating at least a first value of the mass of the vehicle based on the detected force exerted on the suspension assembly in accordance with a first calculation algorithm; in particular, the first calculation algorithm provides for calculating one or more of the following contributions: estimation of the forces acting on the suspension assembly, in particular the vertical spring forces acting on the suspension assembly; estimation of the vertical forces exerted by the end buffers of the suspension assembly; estimation of the antiparallel stroke forces of the suspension assembly; estimation of the damping forces of the suspension assembly; estimation of the damping force of the suspension assembly; estimation of the compensatory forces due to the engine assembly; estimation of the aerodynamic forces particularly a vertical component of the aerodynamic force and/or a pitching component of the aerodynamic force acting on the vehicle; the method comprises the step of estimating the mass of the vehicle based on one or more of said calculated contributions.

4. Method of claim 3, the method comprising the steps of detecting when: the vehicle is stationary and preferably substantially level; and/or moving in substantially uniform rectilinear motion or approximate thereto and preferably substantially level; and calculating and/or enabling the use of the first value of the mass in accordance with the first calculation algorithm only when one of the two conditions is met; preferably the step of detecting when the vehicle is stationary and preferably substantially level; and/or moving in substantially uniform rectilinear motion or approximate thereto provides for implementing step b) and/or step c) and using at least one data item detected during step b) and/or step c) for such detection.

5. Method of claim 3, the method comprising the steps of calculating and/or enabling the use of the first value of the mass in accordance with the first calculation algorithm only when at least one of the conditions below is met: Forward speed less than a first forward speed threshold; Longitudinal acceleration less than a second longitudinal acceleration threshold; Transverse acceleration less than a transverse acceleration threshold; Brake pedal not depressed; Steering angle detected less than a steering angle threshold, preferably this condition is used only if forward speed, preferably longitudinal, detected is less than a fourth forward speed threshold, otherwise this condition is not used; Longitudinal road slope less than a longitudinal slope threshold; Road bank slope less than a bank slope threshold.

6. Method of claim 3, the method comprising implementing the step of receiving in input the data from the detecting device assembly; and/or the values detected via the inertial sensor assembly and defining a set of values, in particular a stiffness curve of the suspension assembly, in particular of each suspension of the suspension assembly, and comparing said values with some parameters of the first calculation algorithm, in particular with a stiffness curve implemented by the first calculation algorithm, to identify difference between them and correct said differences by modifying some parameters in the first calculation algorithm and/or to generate an error signal indicative of a malfunction, in particular a malfunction of the first calculation algorithm and/or a malfunction of the suspension assembly, in particular of one or each of the suspension assembly.

7. Method of claim 1, the method comprising the step of implementing step c), particularly the method comprising the step of detecting the torque delivered by the engine assembly and the detected forward speed and/or the longitudinal acceleration of the vehicle; wherein the method comprises the step of calculating at least a second value of the mass of the vehicle based on the torque delivered by the engine assembly and the detected forward speed and/or the longitudinal acceleration of the vehicle based on a second calculation algorithm, preferably by the following relationship:
$$M 2 ∝ \frac{{F}_{traction} - {F}_{air} - {F}_{friction} - {F}_{slope}}{\dot{v}} .$$

8. Method of claim 7, wherein the method comprising the steps of detecting when the vehicle is accelerating or decelerating along a rectilinear path or approximating to it; and calculating and/or enabling the use of the second value of the mass in accordance with the second calculation algorithm only when said condition is met.

9. Method of claim 7, the method comprising the step of detecting to calculate the second value of the mass in accordance with the second calculation algorithm only when at least one of the conditions below is met: Preferably longitudinal forward speed greater than a fifth forward speed threshold; Preferably longitudinal forward acceleration greater than a forward acceleration threshold; Jerk less than a jerk threshold; Yaw speed less than a yaw speed threshold; Drive torque delivered by the engine assembly less than a first drive torque threshold; Drive torque delivered by the engine assembly greater than a second drive torque threshold; Longitudinal road slope less than a longitudinal road slope threshold; Road bank slope less than a road bank slope threshold.

10. Method of claim 1, wherein the method comprises the step of taking a plurality of measurements over a determined time range, and preferably under unmodified vehicle loading conditions; calculating a measurement quality index and/or a variance of said plurality of measurements to check that it is greater than a quality index threshold and/or is less than a variance threshold; showing one of the measurements or all of the measurements or an average of the measurements if the checking of the quality index and/or variance is successful.

11. Method of claim 1, wherein the method comprises the step of: calculating a first value of the mass of the vehicle based on the data related to the detected force exerted on the suspension assembly through a first algorithm; and a second value of the mass of the vehicle based on the detected drive torque and speed; checking whether the difference between the first value and the second value is less than a first difference threshold value, and if so showing the measurement of the first value and/or of the second value or an average of the first value and of the second value to a user.

12. Estimation system for estimating the mass of a vehicle, particularly a land vehicle, preferably a light commercial vehicle; the vehicle comprising a suspension assembly; an unsprung mass assembly preferably in contact with the ground; and a sprung mass coupled to the unsprung mass via the suspension assembly; and preferably an engine assembly; wherein the sprung mass comprises a compartment on which persons and/or loads may be accommodated; in particular the unsprung mass assembly comprises a plurality of unsprung masses; in particular, the suspension assembly comprises a plurality of suspensions, wherein each suspension couples an unsprung mass of the plurality of unsprung masses with the sprung mass at a suspension point; the estimation system comprising a first detecting device assembly and preferably an inertial sensor assembly; preferably the vehicle comprising a second detecting device assembly;
wherein the first detecting device assembly is configured to be housed on the vehicle, in particular to be coupled to the suspension assembly, and is configured to detect at least one parameter related to at least one force exerted on the suspension assembly in particular by the sprung mass, in particular the first detecting device assembly is configured to detect a plurality of parameters related to a plurality of forces exerted in the plurality of suspension points, in particular a parameter related to the force exerted for each suspension point;
preferably the inertial sensor assembly is configured to be housed on board the vehicle, preferably to be rigidly coupled to the sprung mass of the vehicle, and is configured to detect at least one force acting on the sprung mass, in particular, the inertial sensor assembly is configured to detect a plurality of forces acting on the state of inertia of the sprung mass, preferably the second sensor assembly comprises at least one inertial measurement unit monitoring the dynamics of the sprung mass;
the estimation system being configured to be connected to the second detecting device assembly of the vehicle, preferably via a vehicle communication bus to receive at least one vehicle parameter, preferably the at least vehicle parameter is selected from the vehicle parameter group comprising: torque delivered by the engine assembly; number of revolutions of the engine assembly; setpoint torque delivered/number of revolutions of the engine assembly; gearbox parameter of the engine assembly, preferably which gear is engaged; accelerator pedal position of the vehicle; brake pedal position of the vehicle; steering position of the vehicle; forward speed of the vehicle; wheel rotation speed, particularly rotation speed of each wheel or pair of wheels on the same axle the estimation system being configured to calculate a value of the mass of the vehicle based on one or more of the following parameters: parameter related to at least one force exerted on the suspension assembly detected by the first detecting device assembly; to at least one detected force acting on the sprung mass detected by the inertial sensor assembly; and to at least one vehicle parameter received from the second detecting device assembly of the vehicle; preferably the estimation system comprises a coupled display and the estimation system is configured to show the estimated value of the vehicle mass on the display.

13. Retrofit kit for a vehicle, particularly a land vehicle, preferably a light commercial vehicle; the kit comprising the estimation system made in accordance with claim 12 and is configured to be coupled in communication with the second detecting device assembly of the vehicle particularly through a communication bus of the vehicle; and wherein a display of the system is preferably housable in a driver's cab of the vehicle to show the estimated mass of the vehicle while the vehicle itself is running.

14. Vehicle, in particular a land vehicle, preferably a light commercial vehicle; the vehicle comprising a suspension assembly; an unsprung mass assembly preferably in use in contact with the ground; and a sprung mass assembly coupled to the unsprung mass assembly via the suspension assembly and comprising an engine assembly; in particular, the unsprung mass assembly comprises a plurality of unsprung masses; in particular, the suspension assembly comprises a plurality of suspensions, wherein each suspension couples an unsprung mass of the plurality of unsprung masses with the sprung mass at a suspension point; the vehicle comprising the estimation system of claim 12; the vehicle comprising a second detecting device assembly for detecting at least one vehicle parameter selected from the vehicle parameter group comprising the following vehicle parameters: torque delivered by the engine assembly; number of revolutions of the engine assembly; setpoint torque delivered/number of revolutions of the engine assembly; gearbox parameter of the engine assembly, preferably which gear is engaged; accelerator pedal position of the vehicle; brake pedal position of the vehicle; steering position of the vehicle; forward speed of the vehicle; wheel rotation speed, in particular rotation speed of each wheel or pair of wheels on the same axle.

15. Method for increasing the functionalities of a vehicle, in particular of a land vehicle, in particular of a commercial vehicle; in particular the vehicle is at least partially assembled; wherein the method comprises the steps of installing the estimation system of claim 12 on board the vehicle; in particular the method comprising the steps of coupling the first detecting device assembly to the suspension assembly of the vehicle to detect at least one parameter related to a force exerted on the suspension assembly; coupling the inertial sensor assembly via a rigid connection to the sprung mass of the vehicle; connecting the estimation system to a communication bus of the vehicle to put the estimation system in communication with the second detecting device assembly of the vehicle in order to receive the at least one parameter of the vehicle; installing a display of the estimation system on board the vehicle; the method providing for the step of estimating the mass of the vehicle by means of the estimation system and displaying estimated mass values at a point in the vehicle, preferably inside a cab of the vehicle, by means of the display.
